(19) United States
(12) Patent Application Publication
(10) Pub. No.: US 2018/0113606 A1
(43) Pub. Date: Apr. 26, 2018

(54) APPLICATION STITCHING, CONTENT GENERATION USING VEHICLE AND PREDICTIVE ANALYTICS

(71) Applicants: Evan Crawford, Van Buren Township, MI (US); Sivakumar Yeddnapuddi, Van Buren Township, MI (US); Brian L. Douthitt, Van Buren Township, MI (US); Lori D. Markatos, Van Buren Township, MI (US); Chris W. Gattis, Van Buren Township, MI (US); Mark W. Jarvis, Van Buren Township, MI (US); Sheetal Patil, Van Buren Township, MI (US); Gnanasekaran Ravindran, Van Buren Township, MI (US); Sukumar Ranjeethkumar, Van Buren Township, MI (US)

(72) Inventors: Evan Crawford, Van Buren Township, MI (US); Sivakumar Yeddnapuddi, Van Buren Township, MI (US); Brian L. Douthitt, Van Buren Township, MI (US); Lori D. Markatos, Van Buren Township, MI (US); Chris W. Gattis, Van Buren Township, MI (US); Mark W. Jarvis, Van Buren Township, MI (US); Sheetal Patil, Van Buren Township, MI (US); Gnanasekaran Ravindran, Van Buren Township, MI (US); Sukumar Ranjeethkumar, Van Buren Township, MI (US)

(21) Appl. No.: 15/791,086

(22) Filed: Oct. 23, 2017

Related U.S. Application Data
(60) Provisional application No. 62/412,784, filed on Oct. 25, 2016.
(60) Provisional application No. 62/424,814, filed on Nov. 21, 2016.
(60) Provisional application No. 62/441,547, filed on Jan. 2, 2017.

(51) Int. Cl. G06F 3/0488; G06F 3/01; G06F 3/0482; G06K 9/00

(52) U.S. Cl. CPC G06F 3/04883; G06F 3/017; B60R 2300/207; G06K 9/00885; G06F 3/0482

(57) ABSTRACT

Disclosed herein are devices, methods and systems for integrating one or more applications and/or data sources to present a combined application employing data from the one or more applications and/or data sources. The one or more combined applications may employ data from the source applications and/or data sources, or be relevant to the context presented by the one or more combined applications.

### CROSS-REFERENCE TO RELATED APPLICATIONS

Priority is claimed to Provisional Application Ser. No. 62/412,784, filed Oct. 25, 2016; entitled INTEGRATING FEATURES OF ONE OR MORE MOBILE APPLICATIONS, now pending; U.S. Provisional Application Ser. No. 62/424,814, filed Nov. 21, 2016, entitled APPLICATION STITCHING, CONTENT GENERATION USING VEHICLE ANALYTICS, AND VEHICLE SECURITY, now pending; and U.S. Patent Application No. 62/441,547 filed Jan. 2, 2017, entitled APPLICATION STITCHING, CONTENT GENERATION USING VEHICLE AND PREDICTIVE ANALYTICS, AND VEHICLE SECURITY, now pending. This patent application contains the entire Detailed Description of U.S. Provisional Patent application No. 62/412,784, U.S. Provisional Patent Application No. 62/424,814, and U.S. Provisional Patent Application No. 62/441,547

### BACKGROUND

Mobile applications (“apps”) have been typically designed to operate on mobile devices, such as smartphone and tablet computers, to allow a user portable access to content based on their individual needs. For example, types of mobile apps may include an Internet web browser app, a weather application, an e-mail app, a music or MP3 player app, a calendar app, and the like. These mobile apps operate independently from one another and may pre-loaded on the mobile device or may be downloaded from an app store.

Over time, the increased use of mobile devices in everyday life and the popularity of mobile apps to instantly provide users with desired content and/or to connect multiple users to one another through music, social media, and the like, has motivated other industries to integrate mobile apps into the industry's technology infrastructure. For instance, the automotive industry has developed components to interface a vehicle control unit with the user's mobile device such that the user can access and operate apps, from the mobile device, through their vehicle. By user, this may refer to the driver, passenger, or operator of an autonomous vehicle while not within the vehicle.

However, certain challenges exist with these interfaces. Specifically, the interface may require a wired connection that may frustrate the user while driving or a wireless connection that may be disrupted due to various outside elements. Additionally, some interfaces require the user to physically touch a mobile device to access the content from the mobile app, thereby being distracting or dangerous. Further, if the user is not in possession of their mobile device or if the mobile device is not charged, the user may not be able to use the mobile app. As such, a vehicle interface equipped with mobile apps being independent of the user's mobile device may avoid the above enumerated issues.

### SUMMARY

The following description relates to systems, methods, and applications for integrating applications for a vehicular-based context. Exemplary embodiments may also be directed to any of the system, the method, or an application disclosed herein.

Additional features of the invention will be set forth in the description which follows, and in part will be apparent from the description, or may be learned by practice of the invention.

Disclosed herein are devices, methods and systems for integrating one or more applications and/or data sources to present a combined application employing data from the one or more applications and/or data sources. The one or more combined applications may employ data from the source applications and/or data sources, or be relevant to the context presented by the one or more combined applications.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTIONS OF THE DRAWINGS

The detailed description refers to the following drawings, in which like numerals refer to like items, and in which:

FIG. 1 illustrates an exemplary system level diagram of the aspects disclosed herein;

FIGS. 2-4 illustrates a graphical user interface employing the system of FIG. 1;

FIG. 5 illustrates an exemplary system level diagram of a second embodiment of the aspects disclosed herein;

FIG. 6 illustrates a use-case of the system shown in FIG. 5;

FIG. 7 illustrates an exemplary system level diagram of a third embodiment of the aspects disclosed herein;

FIG. 8 illustrates an exemplary system level diagram of a fourth embodiment of the aspects disclosed herein;

FIG. 9 illustrates an exemplary system level diagram of a fifth embodiment of the aspects disclosed herein;

FIG. 10 illustrates an exemplary system level diagram of a sixth embodiment of the aspects disclosed herein;

FIG. 11 illustrates an exemplary system level diagram of a seventh embodiment of the aspects disclosed herein;

FIG. 12 illustrates an exemplary system level diagram of an eight embodiment of the aspects disclosed herein;

FIGS. 13-15 illustrate exemplary methods of the systems described herein; and

FIGS. 16(a)-(d) illustrate an exemplary graphical user interface associated with the human machine interface to operate the systems disclosed herein.

### DETAILED DESCRIPTION

Detailed aspects of the present disclosure are provided herein; however, it is to be understood that the disclosed aspects are merely exemplary and may be embodied in various and alternative forms. It is not intended that these aspects illustrate and describe all possible forms of the disclosure. Rather, the words used in the specification are words of description rather than limitation, and it is understood that various changes may be made without departing from the spirit and scope of the disclosure. As those of ordinary skill in the art will understand, various features of the present disclosure as illustrated and described with reference to any of the Figures may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations. Additionally, the features and various implementing embodiments may be combined to form further examples of the disclosure.

As explained in the Background section, the conventional implementation of employing mobile apps purely on a mobile device in a vehicle may be non-ideal in certain situations. As such, executing said apps on a vehicle's human machine interface (HMI) may avoid some of the above-noted issues.

The aspects of the present disclosure provide for a platform and method for integrating features of one or more apps to provide an improved user experience and in particular, an improved driving experience. The platform is configured to generate new user features or suggestions for the use of apps while driving based on the features, behaviors, attributes, or functionalities of one or more mobile application. Thus, the platform allows multiple applications to interact with one another to generate new features to perfect the user experience while driving. Further, the platform is configured to generate or trigger new user features or suggestions based on predetermined combinations of one or more mobile application to provide a contextual or predictive user experience.

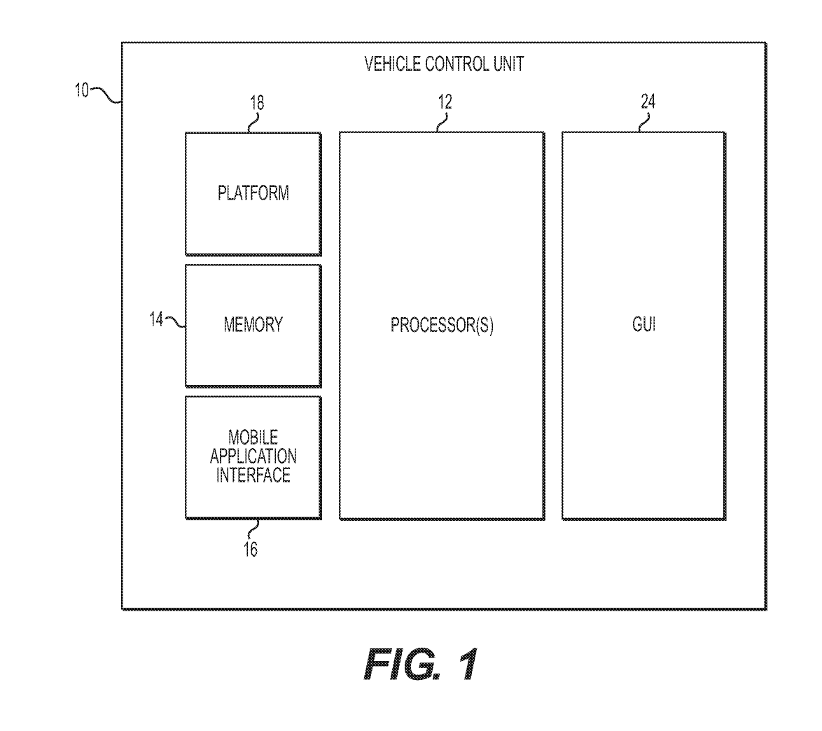

As shown in the block diagram of FIG. 1, a vehicle control unit 10 for operating and integrating features of one or more mobile application to provide an improved user experience is provided. The vehicle control unit 10 includes one or more processors 12 with one or more wireless, wired, or any combination thereof of communication ports to communicate with external resources as well as various input and output (I/O) ports. The processors 12 may also be equipped with hardware and/or software control logic for interacting with or controlling various interfaces within the vehicle control unit 10.

The vehicle control unit 10 also includes a memory unit 14 with any combination of memory storage known in the art and a mobile application interface 16 with one or more mobile applications stored therein. The mobile applications are accessible and executable by the processors 12. Additionally, the mobile application can include any mobile application known in the art and may be pre-programmed within the vehicle control unit 10 or downloaded through an application store accessed through the Internet.

The vehicle control unit 10 includes a platform 18 configured to integrate the features of one or more mobile applications present within the mobile application interface 16. The platform 18 is also configured generate a new feature or user suggestion based information regarding the features provided by the mobile applications or a recipe of predetermined mobile application. Specifically, the platform 18 includes a set of instructions that are accessible and executable on the processors 12. The set of instructions are adapted to generate a new feature or suggestion based information obtained from one or more mobile applications that are in operation by the user (“an active application”) and information obtained from one or more mobile applications that are not in use by the user (“a passive application”). In other words, the platform 12 can take information from one application or active application and supplement this information with information from another application or passive application, to generate a new feature. The information may include one or more features, attributes, or behaviors of the particular mobile application.

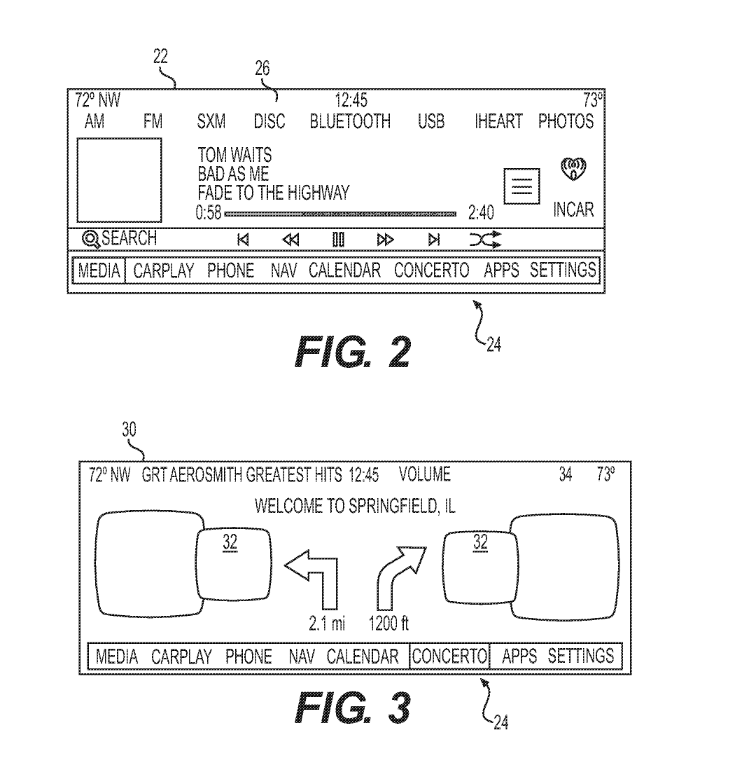

The vehicle control unit 10 may further include or be connected to a graphical user interface (GUI) 24 with for displaying new features or suggestions to the user. The GUI 24 may include various buttons, voice sensors, gesture sensors, or a touch screen, such that the user can interact with and select various mobile apps or features displayed thereon. The new feature or suggestions displayed to the user may be depicted in words, pictures, or a combination thereof. For example, as shown in FIG. 2, a user may be listening to music through their music application 22 on the GUI 24 from a compact disc (CD) 26. The content associated with the CD, such as song title, album title, and artist's name, may not be recognized by the vehicle control unit 10 when played. As such, another music application 28, may supplement the information in the music application 22 to display the content to the user. In another example, if the user is listening to music on the AM, FM, satellite, or internet radio through the music application 22, other music applications may present an option to download the particular song or album that the user is listening to.

Additionally, the set of instructions may be further configured to generate the new feature or suggestion based on one or more predefined combinations triggered by the mobile applications to provide a contextual and/or predictive user experience. The predefined combinations may be pre-programmed based on predetermined selections of or interactions with the mobile applications, or may be dynamically programmed based on user's interactions or patterns learned over time. The number of recipes in the set of instruction may be less than or greater than the number of mobile applications present within the mobile application interface 16, or may be equal to the number of potential mobile application combinations.

In certain of the cases noted above, the information input into the platform may be provided from data from a mobile app. In other cases, the platform 18 may be able to use information provided by the vehicle, through sensors and electronic components integrated into the vehicle control unit 12 (such as, but not limited to a speed sensor, location sensor, climate sensor, and the like). As such, the predictive features of recommending applications may be integrated with other information.

In addition to notification of maintenance, a GUI may be provided to instruct the owner/operator of the vehicle on how to fix these problems. The instructions may be locally provided, or alternatively, retrieved from a network source.

In one example, as shown in FIG. 3, the recipe may include the selection of one or more predetermined mobile applications and may provide a particular feature or suggestion based on the predetermined mobile applications. Specifically, if the user selects the navigation application 30 (shown on the GUI 24), this may trigger and output various other applications 32 based on the vehicle's detected location that the user might be interested, such as a coffee shop application or restaurant. The user may then activate those applications 32 to preorder an item and/or to obtain directions to its closest physical location.

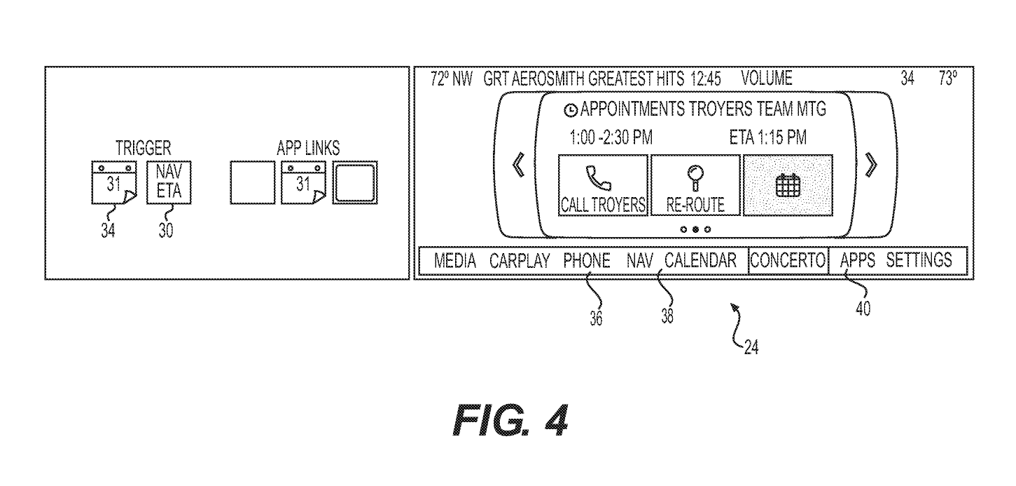

In another example, as shown in FIG. 4, a combination of mobile application may trigger a feature or suggestion. For instance, the time of day 34 and the selection of the navigation application 30 may generate an estimated time of arrival to a destination. When this information is coupled with information relating to an appointment with a party saved in a calendar application 34, other applications such as a phone call button 36 to call to inform the other party that the user will be late, a re-route button 38 to change the user's route, and/or a reschedule button for easily rescheduling the appointment may be provided.

Another aspect disclosed herein incorporates vehicle-to-vehicle (V2V) communication with the aspects of the platform 18 disclosed above. Certain apps may be directed to locations which are not in the vicinity of the current vehicle in which the platform 18 is installed in. As such, these apps may incorporate a V2V communication protocol to interface with a vehicle in a different location to obtain a real-time camera or video feed of what the other vehicle(s) are observing.

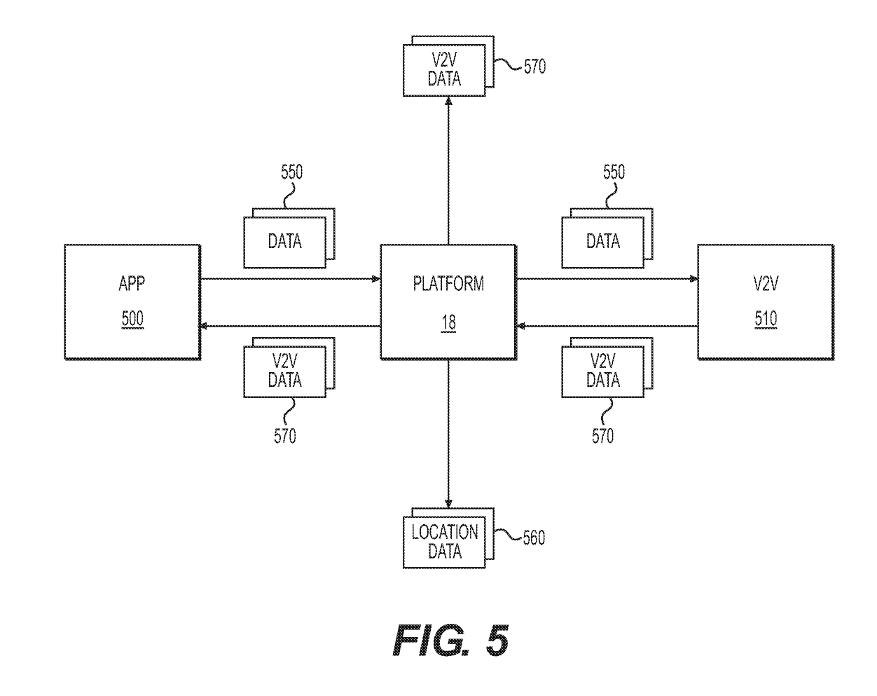

As shown in FIG. 5, if an app 500 generates data 550, the data 550 may be propagated to the platform 18 to perform the aspects described herein. If the data 550 includes location data 560, the platform 18 may determine that said locations are not visible to the present vehicle. In this way, the V2V app 510 may be initiated.

Once the V2V app 510 is initiated, data associated with the location data 570 may lead to the generation of requests from vehicles at those locations. Thus, V2V data 570 may be generated, and automatically propagated back to the platform 18. In certain situations, the V2V data 570 may be employed by the app 500, and integrated into the function of the app 500. In other cases, the V2V data 570 may be integrated with a pre-existing vehicle electronic system, another application, or some combination of the above.

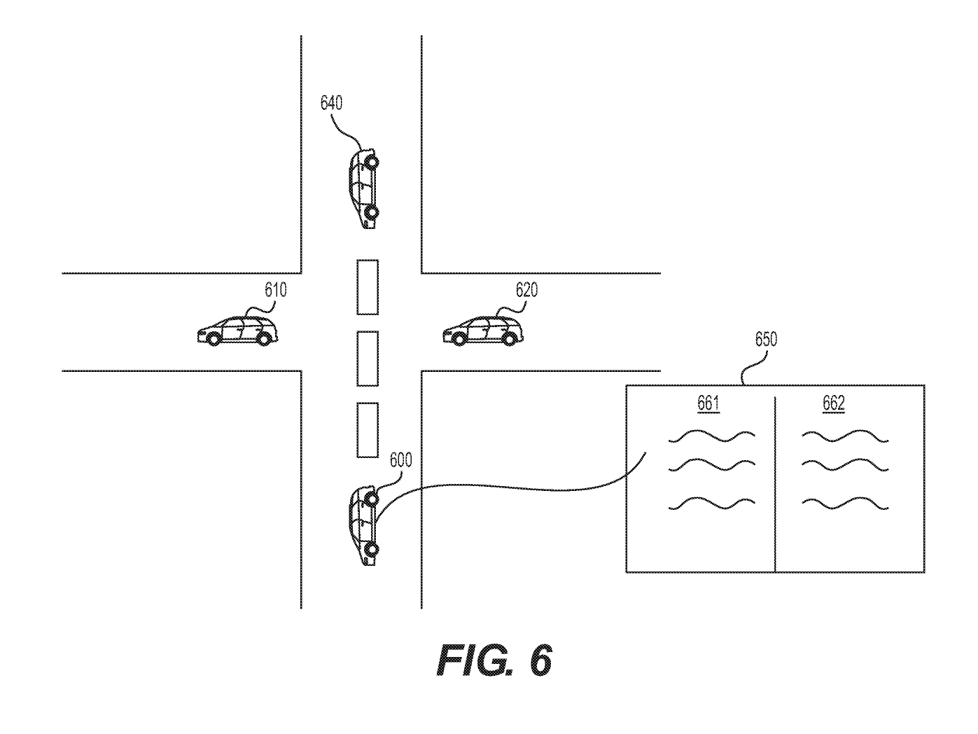

In the example shown in FIG. 6, a vehicle 600 and a HMI 650 is shown. The HMI 650 includes a display 660, with screens 661 and 662 shown. Vehicle 610 and 620 are situated in other locations.

In response to the vehicle 600 engaging with a traffic app that generates the locations of vehicle 610 and 620 as potential routes to travel on, a V2V app may initiate, thereby providing a direct access to either an image or video feed associated with vehicles 610 and 620, respectively.

In another example, a vehicle 640 ahead may provide a video/image feed showing what traffic is like ahead (i.e. in locations where the vehicle 600 is unable to see or observe. In these cases, the retrieved data from vehicle 640 may be merged in a display, such as a HUD, and thus overlaid over obstructing images obscuring the view of vehicle 600.

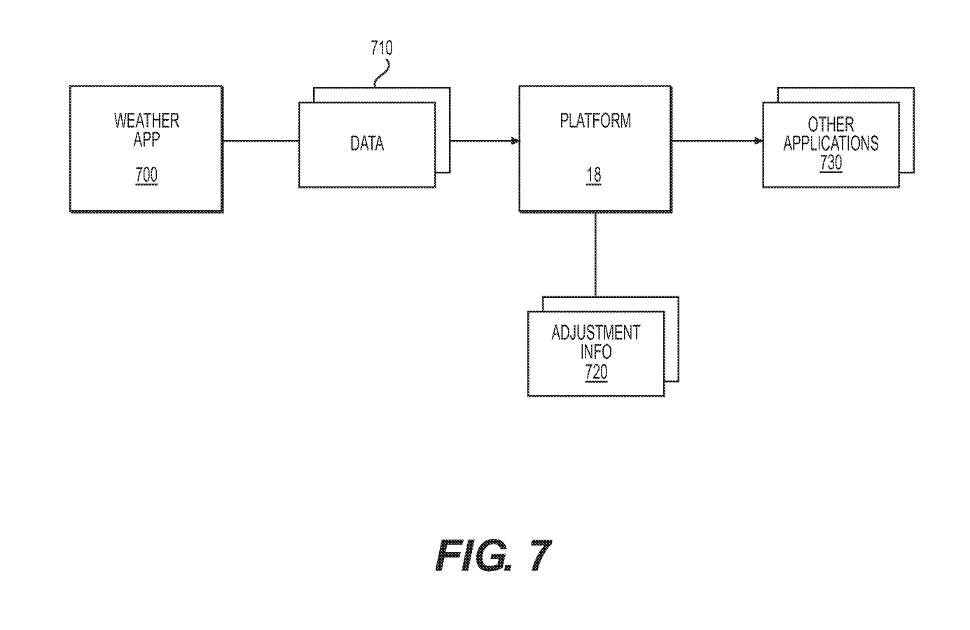

In the example shown in FIG. 7, data 710 from a weather app 700 (or any app associated with detecting weather and environment conditions) is propagated to the platform 18. Through the aspects disclosed herein, the data 710 is processed, and adjustment information 720 is automatically obtained. The adjustment information 720 may be propagated to another vehicle control system which monitors driver safety, lead to the instigation of another application, or the like.

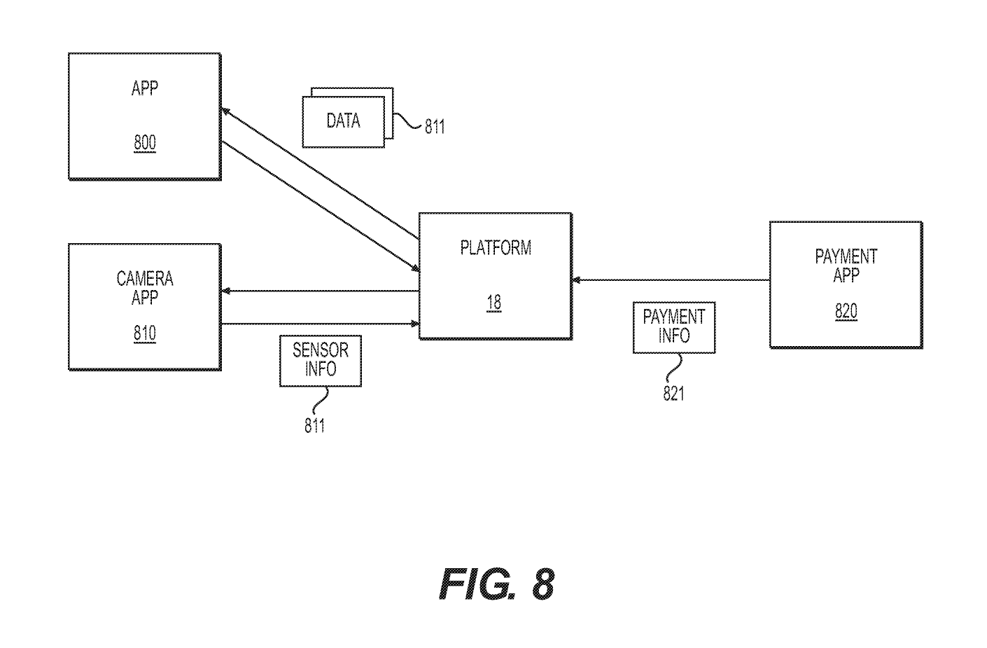

FIG. 8 illustrates another embodiment of the aspects disclosed herein related to the platform 18 integrating applications associated with the payment for a good or service.

Certain apps may be incorporated with a payment component. For example, an app may employed at a drive-through location, and be used to purchase goods or services. For example, if an app 800 is engaged while a vehicle is at a drive-through location, a camera app 810 may detect information about the good's being purchased. The information from the camera app 810 may be integrated via platform 18 to provide input data to app 800.

Additionally, a payment app 820 may be instigated, thereby authorizing the transfer of funds from the user associated with the vehicle to a third-party either identified via the camera app 810 or some other sensor. A payment app 820 may be authorized to engage with the user's financial institution, or to some repository of funds/credits associated with payment.

In the example discussed above, an application is employed as a trigger, along with an integrated vehicle-based sensor (in this example a camera), to instigate a third application. For example, a map/location-based application may alert the platform 18 that the vehicle-driver is at a specific location (i.e. a drive through), the camera app may alert the system that the driver has ordered a specific amount of food/items. Accordingly, the payment app 820 may be instigated to pay that specific amount when prompted or permited.

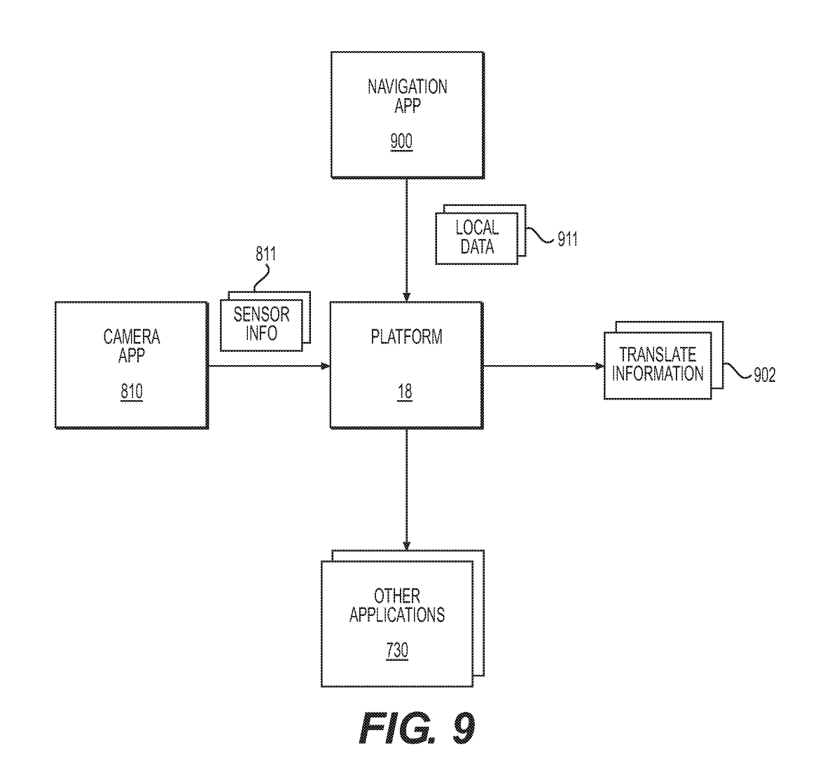

FIG. 9 illustrates another embodiment of the aspects disclosed herein related to the platform 18 integrating application associated with employing navigation.

As shown in FIG. 9, a navigation app 900 communicates information (local data 911) associated with a present location. From said information, the navigation app 900 may determine the exact location of the vehicle, as well as platform 18 or any program employed to determine or use a submitted location.

The platform 18 may communicate said location information, and correlate said location information with the user's either entered-in or detected native location, and provide alerts, auxiliary information, or suggested applications based on said known information.

For example, the location information may be used to indicate to the user that said driving customs and practices are different than the user's native environment. For example, if the user travels from a first jurisdiction to a second jurisdiction, the platform 18 may employ an app to indicate that a parking or driving practice is either allowed or disallowed.

In addition to location information, other sensed information may be used as inputs to various applications. For example, a sensor may detect a restriction or guidance on driving or parking. As such, an app may use this information to notify the user of said restrictions or guidance, or employ the data in its operation.

For example, a parking app (that automatically pays for parking), may not pay for parking if a sign detects that parking is temporarily prohibited. In another example, if the vehicle is oriented in the wrong direction, a notification app may let the user know that this is the case.

In another instance, the location information may be used to determine that the signs and text are not in the user's native language. As such, a camera app 910 may employ the location information and be instigated to detect signage in other languages. Accordingly, an HMI app 920 may output the signs in a language understood by the user. In another case, if a HUD display is implemented, the HMI app 920 may render translated information onto the HUD.

The other applications may pertain to apps associated with local places of interests, road toll paying applications, parking applications, and the like.

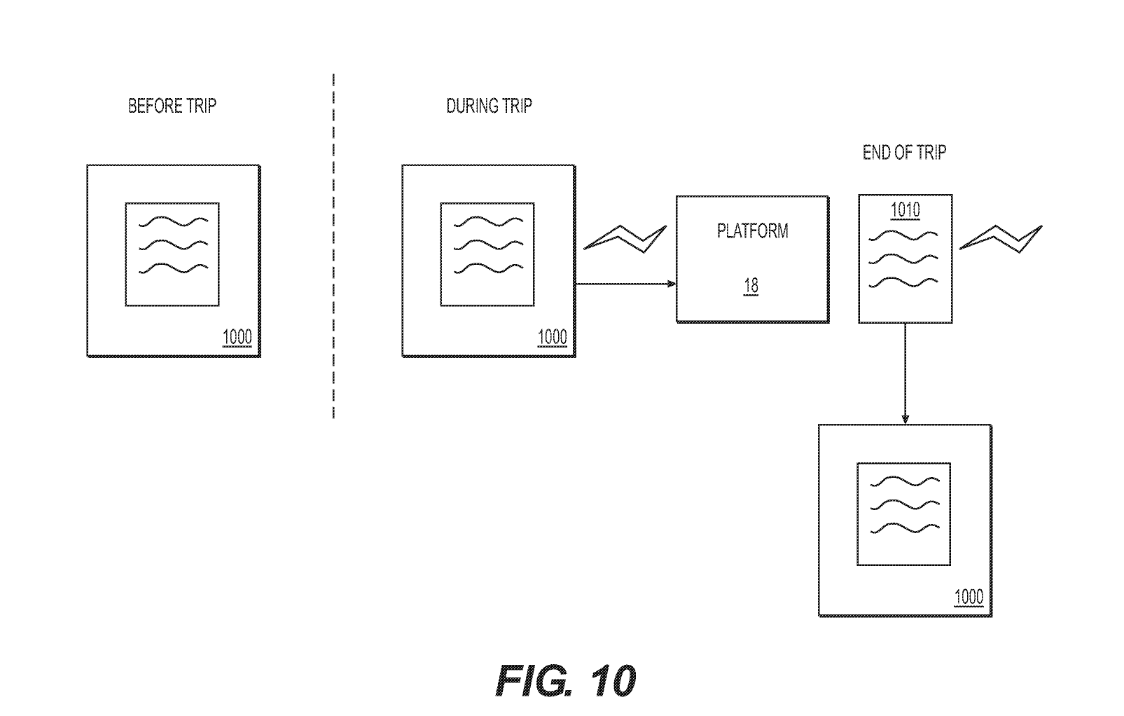

FIG. 10 illustrates another example of an alternate embodiment of platform 18 according to the aspects disclosed herein.

As shown in FIG. 10, a mobile device 1000 is paired to the vehicle. Employing the concepts disclosed herein, the platform 18 can detect that the user is about to leave the vehicle, and walk the remaining portion.

For example, if prior to being paired to the vehicle (or a vehicle's computer), the user enters in a destination, said destination may be integrated with the platform 18. After all the predictive data associated with the platform 18 is performed, after the driver leaves the vehicle, the apps and information generated employing the techniques discussed herein may be communicated to the mobile device 1000. As explained above, the downloading may occur as the platform 18 determines that the vehicle is at a predetermined distance or location from its pre-entered destination.

For example, if a user is planning to go to an event, and can only find parking several miles away, the aspects disclosed in FIG. 10 may be employed. First, a user may download tickets to the event via their mobile device 1000. When the mobile device 1000 is paired with the platform 18 (or an associated vehicle computer), an application may start navigating said user to its destination. Once the user is near their destination, or the vehicle stops, the platform 18 may instigate a further communication with the user to communicate the user's mobile device 1000 to perform the remaining steps of the navigation.

Alternatively, the platform 18 may be detected to identify that the destination is either reached or at a proximal location to said destination. At this point, data 1010 may be communicated to the mobile device 1000. For example, various applications associated with the destination may be communicated (data 1010).

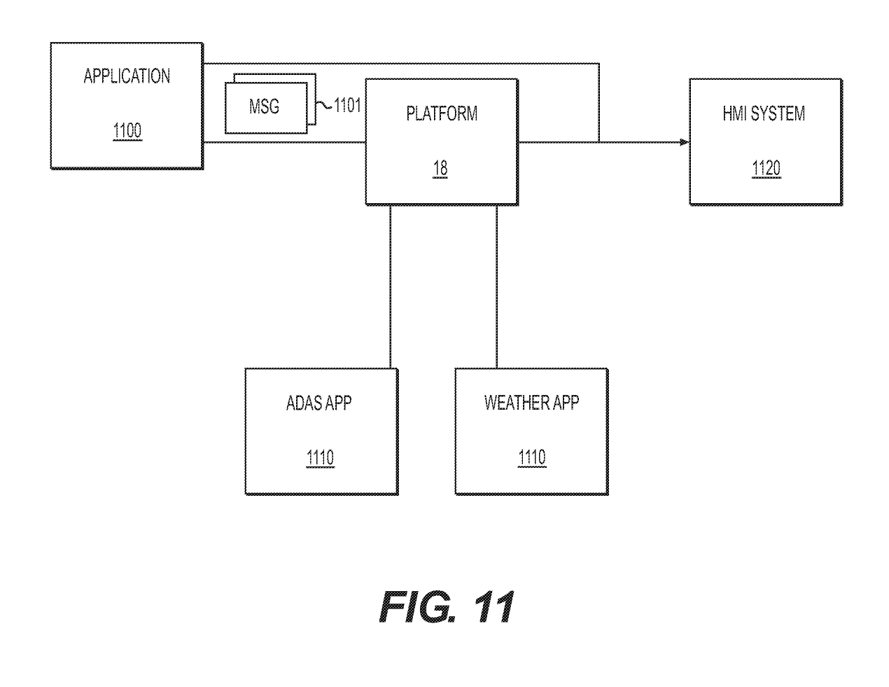

FIG. 11 illustrates another example of employing the platform 18 to integrate applications for improved safety. As shown in FIG. 11, application 1100 receives information to push to a user in a vehicle. Employing the aspects disclosed herein, the application 1100 may receive a signal from another ADAS application 1110 indicating that it is safe to present said information to a HMI system 1120 for user consumption.

For example, certain messaging systems may be advantageously provided at certain times to prevent distraction. Thus, a user may be prevented from receiving said messages unless a detection is made that the user's vehicle is at a stopped or at a stalled condition (i.e. a traffic light, a traffic jam, or the like).

In another example, a weather app 1130 may be configured to control the flow of information based on whether the detected weather indicates that a driving condition is dangerous or not advantageous for a user to view messages. Thus, if the user is driving in a bad storm, the application 1100 may be configured to prevent the deployment of information to the user until the bad weather passes through, or some other override signal (from another application or messaging system).

In addition to providing information to the user about driving more carefully, these cues/triggers from the weather app 1130 or ADAS application 1110 may be employed by other vehicular systems associated with driver safety, like lane keeping systems, adaptive cruise control systems, and the like.

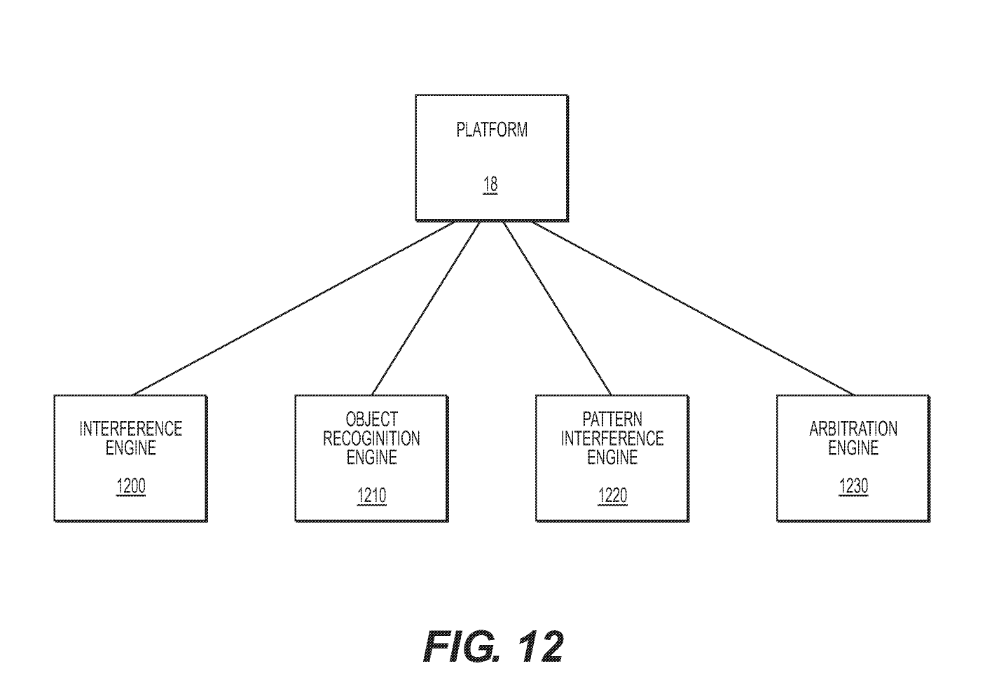

FIG. 12 illustrates various engines associated with platform 18. An implementation of platform 18 may incorporate one, some, or all of the engines illustrated herein.

As shown in FIG. 12, the platform 18 includes an interference engine 1200, an object recognition engine 1210, a pattern inference engine 1220, and an arbitration engine 1230. The various aspects disclosed associated with each engine will be described below.

The interference engine 1200 is configured to align data sets with differing parameters. The purpose of such an alignment is to ensure that data sourced from a single application is also combined and augmented with related applications. As such, when the platform 18 determines that certain apps are used in conjunction with each other, data sourced from and to those apps may be collectively grouped together.

For example, if a navigation app detects that a specific location has been reached (i.e. from a calendar app), several apps grouped with ‘checking in’ through the interference engine 1200 may be instigated with a check-in request.

Essentially, applications with similar data inputs, data outputs, and functions are grouped together. Additionally, applications associated with similar reactions and cues may also be grouped together (i.e. expressed preferences, use patterns, and the like).

The object recognition engine 1210 may be employed with a vehicle sensor coupled to the vehicle control unit. For example, an object may be photographed or detected via a sensor, with said object being communicated to the platform 18. The platform 18, employing the aspects disclosed herein, may be configured to use the sensed image as an input for either searching for an app, a combination of apps, or prompt the user for further instructions.

For example, if the user places a coffee cup (of a specific brand, for example) in front of a camera, and the platform may provide visual data of an app associated with the brand merged with navigation information as to the nearest location.

The pattern interference engine 1220 detects specific inputs associated with the user's action, the user's interaction with the vehicle, and learns application usage based on said information.

The arbitration engine 1230 determines the mode which the user or vehicle is in, and recommends apps, performs app integration (as described above), re-arranges application interfaces, based on the determined mode correlated with learned behavior from previous interactions.

Additionally, the arbitration engine 1230 may be integrated with a detection device capable of biometrically detecting the user's reaction and current state. For example, a camera app may be installed in the vehicle, and configured to detect the user's mood. Carious apps may be predetermined to be appropriate in said mood detection. For example, if the user is detected as being angry, calming music (as predetermined) may be played. If the user is detected as being in a state of tiredness, “energetic music” may be played, or apps requiring more engagement may be provided.

The arbitration engine 1230 may even generate meetings based on a detection of the user's schedule, preferences, and location. For example, if a calendar app 1430 indicates that four people will be in the same area (or are planning to meet), the platform 18, employing the arbitration engine 1230, may determine a place to go (based on food/service apps), and instigate a navigation app to allow the user's vehicle to go to the determined place.

In another example, the arbitration engine 1230 may determine that said user is stressed or had a busy schedule (through either a calendar app or detection of communications, or a combination thereof). In this instance, the arbitration engine 1230 may provide applications and recommendations based on said determination

In certain cases, the platform 18 may be provided with an interface to external peripheral devices, either wired or wirelessly provided. In these cases, the external device may be selectively allowed access to some applications, while not allowed access to other applications. Or, the external devices may not be allowed access to portions of some of some applications, or a combination of some applications.

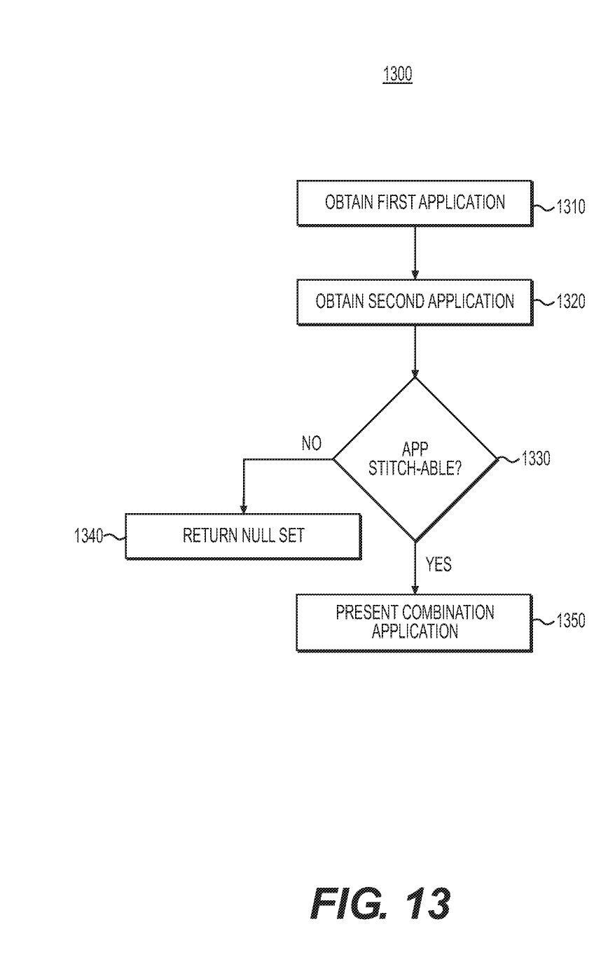

FIGS. 13-15 illustrate methods 1300, 1400, and 1500 employed with the aspects disclosed herein, and configurable or programmable via processor being employed to implement platform 18.

FIG. 13 illustrates a method 1300 illustrating the aspects of stitching/combining multiple applications according to the aspects disclosed herein.

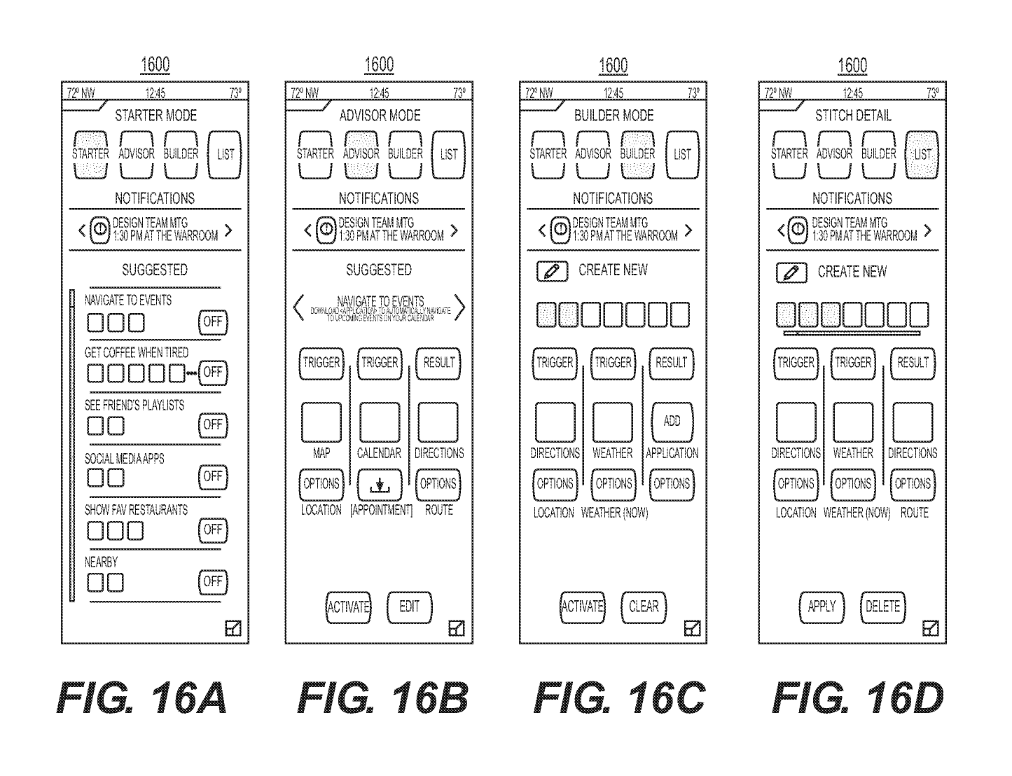

As shown in operations 1310/1320, a first application and a second application are obtained. As shown in the GUI in FIGS. 16(a)-(d), a user may select the applications to be stitched. Alternatively, the platform 18 may present stitchable applications. Alternatively, a first application may be executed, and applications either locally available, accessible via a networked source (for example cloud-storage), or the like may be presented as options to stitch.

In operation 1330, the two obtained applications undergo a determination to ascertain whether the applications are stitch-able employing the aspects disclosed herein. By being stitch-able, either data associated or outputted with the first/second applications are combine-able and usable with at least one other application (as such, the combination of applications are shown in operation 1350), or said two applications being used together indicate that a third application may also be relevant to the current context and usage (this may be determined by either a predefined relationship or through learning that indicates a third application is often used in combination with the two obtained applications).

Alternatively, if the platform 18 indicates that no known relationship of the at least two applications are available, a null set may be returned (1340).

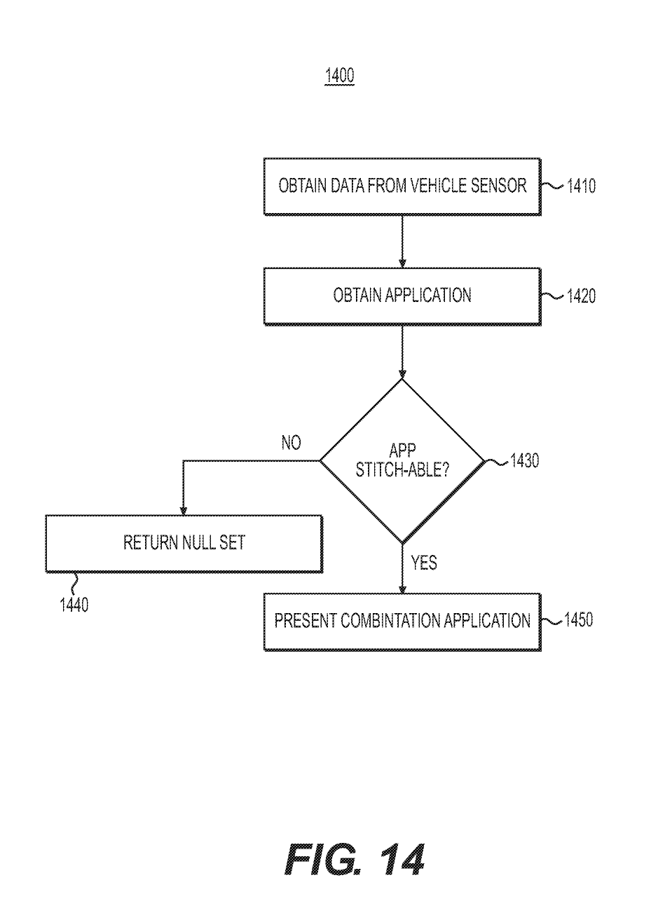

FIG. 14 illustrates another method 1400 employing application stitching via platform 18 according to the aspects disclosed herein.

In operation 1410, data from a vehicle sensor is obtained. As discussed above, this may be any sensor originated information, such as an invehicle camera, external camera, a microphone, a mechanical sensor, a weather sensor, or other sensors employed in the vehicular context.

In operation 1420, an application is chosen as well. Progressing to operation 1430, a determination is made as to whether the application chosen/obtained is stitchable. The determination may occur automatically, by the execution of the application, and an iterative determination of each sensor available. Alternatively, a user may select an option through an available HMI to determine whether a stitch is available.

As shown, and similar to FIG. 13, either a null set is returned (1440), or a list of combineable applications is presented (1450).

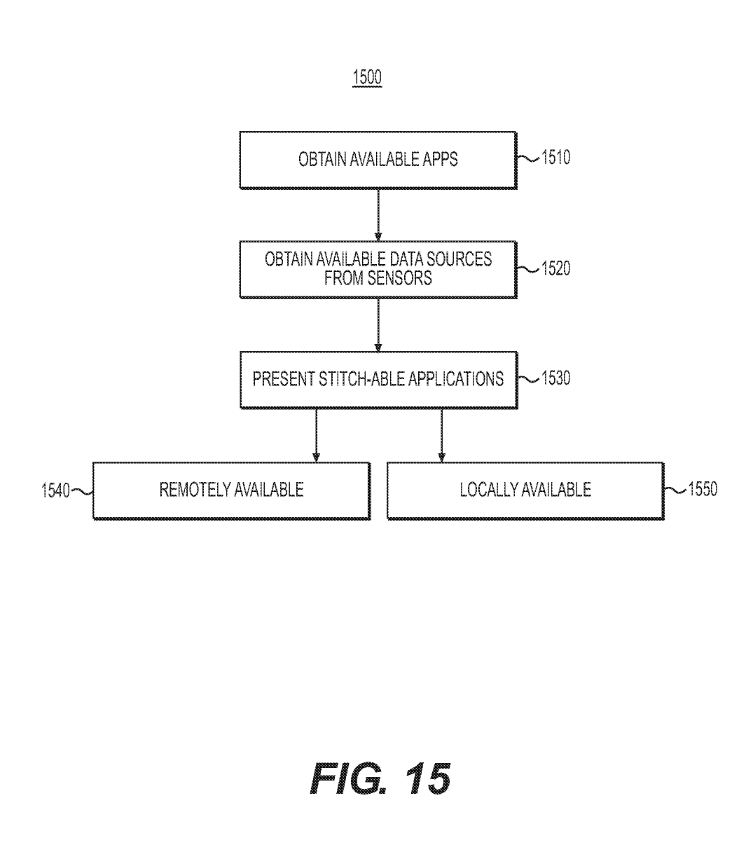

FIG. 15 illustrates another exemplary method 1500. In operation 1510, the available applications associated with platform 18 are obtained. These may be applications presently available via the platform 18. Alternatively, these may be applications downloadable or acquirable via a network source (or available to be executed while stored on a network source).

In operation 1520, the available data sources associated with sensors electrically coupled to the vehicle platform 18 is also obtained. For example, vehicle-based sensors, component based sensors, cameras, microphones, and the like are obtained, as well as the data associated with said sensors.

In operation 1530, the platform 18 presents all stitch-able options. I.e., all applications associated with the combination and permutation of the obtain applications, the obtained sensor data sources, or a combination thereof, is presented to a user associated with platform 18 (for example, via a HMI).

The presented stitch-able applications may be either remotely available (i.e. for download) 1540 or locally available 1550, or a combination thereof. In an alternate embodiment, a developer of the platform 18 may restrict the subset of combine-able applications that are stitch-able, or determined to be stitch-able.

Various combinations of applications may be employable, with several exemplary embodiments described below. For example, the applications may be exported to a mobile device. In this way, daily habits may trigger certain stitched applications. The platform 18 may ascertain that a user often times orders coffee at a specific time or route. As such, when the route is entered, and a time of day is ascertained, a coffee application associated with a specific coffee shop may be instigated.

Further, a time of day application or data source may be integrated with a historical route database application. In this way, even without entering an application, an arrival time may be ascertained as well.

In certain situations, a time of day application may be integrated with a weather application that allows information associated with sunlight to provide guidance as to providing a route for the driver with a navigation application with the least amount of glare.

In another example, the platform 18 may integrate an application for navigation, and a time of day application, and stitch together a reminder indicating where the user/driver parked their car.

As explained above, in addition to stitching applications with other applications, the applications may be stitched along with vehicle-based sensors, such as accelerometers, gyroscopes, barometers, proximity sensors, and the like. These vehicle-based sensors may be integrated with driving-based applications, and other data acquisition software modules, and provided to other applications.

For example, based on detecting the user's driving preference, and a navigation application, a traffic/road based application may ascertain or determine an ideal route for the driver. Alternatively, if based on the road being determined to be difficult to drive on, an entertainment application may be controlled accordingly (for example, being turned off/on).

In addition to vehicle-based sensors, biometric sensors associated with the vehicle, or incorporated in a wearable device may also be stitched with applications to determine or create new applications to be engaged with or executed.

FIGS. 16(a)-(d) illustrates that the above-disclosed concepts associated with merging applications via a vehicular interface may be modifiable or set by the user. As shown in FIG. 13, a user may be presented with a combination of apps to be initiated with initial stimuli.

For example, in a first mode (labeled starter mode), the listing of combined apps is provided. In a second mode (shown as advisor mode), the system determines which applications are appropriate for said time/place. As shown, the combination of instigating a map application and a calendar application, leads to a result application (determining an optimal route via traffic).

In another mode (builder mode), users can customize application triggers to create a result. For example, if app 1 and 2 are selected, the result application may be customizeable based on a user predefinition.

In addition to all of the above, the system may record or keep a note of all activities associated with app creation and merging together based on previous activities, user selections, or automatic selections associated with information provided from third-parties.

The foregoing disclosure has been illustrated and described in accordance with the relevant legal standards, it is not intended that these examples illustrate and describe all possible forms of the present disclosure, thus the description is exemplary rather than limiting in nature. Variations and modifications to the disclosed examples may become apparent to those skilled in the art and fall within the scope of the present disclosure. Additionally, the features and various implementing examples may be combined to form further examples of the present disclosure.

We claim:

1. A system for integrating one or more applications in a vehicular-based context, comprising:
a data store comprising a non-transitory computer readable medium storing a program of instructions for the providing;
a processor that executes the program of instructions, the instruction comprising the following steps:
being provided a first application executed via a vehicle-based human machine interface (HMI);
being provided a data source associated with the vehicular-based context; and
combining the first application and the data source to present an option of one or more stitch-able applications based on the combination.

2. The system according to claim 1, wherein the combined stitch-able application employs data from the first application and the data source.

3. The system according to claim 2, wherein the data source is a second application executed via the vehicle-based HMI.

4. The system according to claim 1, wherein the combinations are selected via past usage patterns.

5. The system according to claim 1, wherein the combinations are predetermined.

6. The system according to claim 1, wherein the processor is configured to determine that data generated from both the first application and the data source is employable via the one or more stitch-able applications.

7. The system according to claim 1, wherein the processor is configured to interface with a network-source to retrieve the one or more stitch-able applications.

8. The system according to claim 1, wherein the data source is a vehicle-based sensor.

9. The system according to claim 2, wherein the second application is a vehicle-to-vehicle (V2V) application, the V2V application being defined as a network conduit to another vehicle.

10. The system according to claim 1, wherein the first application is a weather application.

11. The system according to claim 1, wherein the first application is a navigation application.

12. The system according to claim 3, wherein the first application is a calendar application, and the second application is a navigation application, and the one or more stitch-able applications includes an application directed to a specific place of commerce.

13. The system according to claim 3, wherein the one or more stitch-able applications is displayed after a user selects the first application and the second application.

14. The system according to claim 1, wherein the data source is a biometric sensor.

15. The system according to claim 4, wherein the biometric sensor is located on the vehicle.

16. The system according to claim 14, wherein the biometric sensor is located on a wearable device worn by a user.

17. The system according to claim 1, wherein the one or more stitch-able applications is stored on a mobile device in a networked relationship with the vehicle-based HMI.
